(19) United States
(12) Patent Application Publication
(10) Pub. No.: US 2008/0097899 A1
(43) Pub. Date: Apr. 24, 2008

(54) METHOD AND SYSTEM FOR ELECTRONIC SETTLEMENT OF CHECKS

(75) Inventors: STEVE JACKSON, CLIFTON, NJ (US); JOSEPH PAWELCZYK, MORRIS PLAINS, NJ (US); JOSEPH MIRABELLA, BAYONNE, NJ (US)

Correspondence Address: FITZPATRICK CELLA HARPER & SCINTO, 30 ROCKEFELLER PLAZA, NEW YORK, NY, 10112, US

(73) Assignee: The Clearing House Payments Company L.L.C., New York, NY (US)

(21) Appl. No.: 11/777,690

(22) Filed: Jul. 13, 2007

Related U.S. Application Data
(60) Provisional application No. 60/830,874, filed on Jul. 14, 2006.

(51) Int. Cl. G06Q 40/00

(52) U.S. Cl. 705/39; 705/35

(57) ABSTRACT

A system is provided for settling cash letters containing check images that are exchanged by banks connected to an image exchange system (IEX). Settlement amounts are computed and sent to the Federal Reserve Banks' National Settlement Service (FRBNSS) for settlement based upon business rules. Further, a method is provided for processing a financial check transaction between a plurality of financial institutions, including at least first and second institutions, the method including providing electronic check data, relating to at least one check to be paid by the second institution, from the first institution to the second institution to effect an automatic check presentment; and automatically performing an electronic settlement determination for the at least one check, based on the electronic check data and predetermined business rules.

### CROSS-REFERENCE TO RELATED APPLICATIONS

This application claims the benefit of U.S. Provisional Patent Application No. 60/830,874, filed Jul. 14, 2006, the entire disclosure of which is herein incorporated by reference. This application is related to U.S. application Ser. No. 10/768,821 filed Jan. 30, 2004, the entire disclosure of which is herein incorporated by reference.

### BACKGROUND OF THE INVENTION

1. Field of the Invention

The present invention relates generally to electronic payment and check settlement systems and methods, and more particularly, to settling cash letters containing check images exchanged by banks connected to an image exchange system. The present invention also generally relates to a distributed system architecture for implementing these systems and methods.

2. Related Art

Various programs are being implemented by financial institutions to transition the traditional paper-check collection and return process into an electronic process. Such efforts are being undertaken to reduce the costs, time delays, and other problems associated with the processing of the over 40 billion paper checks collected per year in the United States.

In a conventional, paper-based check clearing or collection process, paper checks are physically delivered by the writer of a particular check (i.e., the payor) to the person or entity to whom the check is made out (i.e., the payee). The check is deposited in the payee's financial institution, which is referred to as the bank of first deposit or the depositary bank. The check is physically delivered directly or indirectly by the depositary bank to the bank on which the check is drawn (i.e., the paying bank or payor bank) and ultimately back to the payor.

Generally, checks delivered to a paying bank are accompanied by a cash letter, which lists all of the checks being delivered and information about each check, including the amount of the check. Delivery of the paper check from the depositary bank to the paying bank directly or indirectly involves numerous check sorting processes and multiple intermediary collecting banks as the check moves through the collection process. If the check for some reason is not honored by the paying bank, e.g., because the payor has insufficient funds, then the check travels back to the depositary bank and the payee.

This conventional check collection system, in which billions of paper checks are physically shuffled back and forth among various entities, entails significant costs and time delays. Moreover, due to banking regulations, the collection process must take place within strict schedules. For example, the paying bank generally has less than two days from the time a check is presented by the depositary bank to decide whether to return the check and recover its payment before the check is considered final. Also, the payee may lose interest for each day's delay in the collection process. Of course, the collection process is vulnerable to physical phenomena, e.g., transportation delays caused by severe weather, vehicular malfunctions, or vehicular accidents.

Electronic check presentment (“ECP”) is one type of electronic process that is being used to supplement the traditional paper-check collection process. Currently, in ECP, the depositary bank (also referred to herein as a “collecting bank”) electronically reads from each paper check the account number, routing transit number (“RTN”), and the check number, which are printed on the check in a magnetic-ink character-recognition (“MICR”) line (this data is referred to herein as “MICR data”), and other information as well, such as the dollar amount of the check, for example. This information is included in an electronic record, referred to as an “electronic cash letter,” which is sent to the paying bank. The original paper checks sometimes are sent at a later time.

For example, a depositary bank may electronically send to a paying bank an electronic cash letter for checks deposited on Monday, which will reach the paying bank by Monday evening. The paper checks usually arrive at the paying bank by the next day (Tuesday), in time for the return process. After the paying bank receives the paper checks and reads the MICR data from them, the paying bank reconciles the paper checks with the electronic cash letter received earlier to determine missing or free items. For items to be returned, e.g., for lack of funds on deposit, the corresponding paper checks are pulled and returned to the depositary bank.

One disadvantage of conventional ECP is that it is not entirely paperless, because it still requires the movement of paper checks.

To reduce the movement of paper checks, a check-image exchange process, also referred to herein as “check truncation,” has been used as an alternative. In check truncation, at some point in the check clearing process before an original paper check typically reaches the check writer's bank, a digital image of the paper check is produced and sent in lieu thereof for further processing. The original paper check may then be stored or destroyed.

In actual practice, check truncation is not widely used and its use often is limited to, for example, imaging cancelled checks in order to replace conventional customer statements with on-line statements, in which a check writer may view images of his or her cancelled checks through the Internet and, if desired, selectively print one or more of them. In order to increase the efficiency of the check clearing process, it is desirable to implement an ECP system with check truncation at the depositary bank or at an intermediary entity, such as a Federal Reserve Bank.

Another disadvantage relates to the architecture of the current ECP system. FIG. 1 schematically depicts this ECP system, which is structured in a “hub-and-spoke” configuration.

In the hub-and-spoke configuration of FIG. 1, all electronic cash letters 100 are transmitted by “spoke” depositary or collecting banks 102 (e.g., Bank A) to a central “hub” or switch 110, to be routed to “spoke” paying banks 104 (e.g., Banks B, C, and D). A number of cash letters 100, each of which is directed to a different paying bank 104, may be combined into a single electronic cash letter file 115 with a single file header 105. Upon receiving an electronic cash letter file 115, the switch 110 deletes the file header 105, separates the combined file 115 into separate electronic cash letter files 120 for each paying bank, provides a new file header 125 for each file 120, and sends each file 120 to a separate queue 130 for each corresponding paying bank 104. The paying banks 104 then periodically retrieve the electronic cash letters 120 from their particular queue 130. The switch 110 also performs certain quality control functions, e.g., preventing processing of duplicate files and reporting functions.

However, hub-and-spoke configurations have a disadvantageous latency in the transfer of electronic cash letters and/or electronic cash letter files due to the processing time required at the central hub or switch. Such delays are particularly significant if the electronic cash letters and/or electronic cash letter files are accompanied by check-image data, as would be in an image exchange system.

Presently, banks that use ECP systems generally send out files, i.e., electronic cash letters and/or MICR data, once a day after the close of business. Banks that receive the files then process the files once a day. Thus, it generally takes at least two days to clear a check. Such an arrangement, however, fails to utilize the capabilities of ECP systems to electronically communicate large amounts of information quickly. That is, current arrangements facilitate the transmission of large amounts of data, but do not significantly speed up the process of clearing checks. What is needed therefore is a system and a process for clearing or settling checks, in which the transfer of information between banks is coordinated in a manner that enables a check to be settled in less than two business days.

### SUMMARY OF THE INVENTION

The present invention addresses the above-described need by providing a system, method, and computer program for efficiently clearing and settling checks.

According to an aspect of the present invention, the system includes: a plurality of first entities (such as banks), each first entity being communicatively connected to at least one distributed traffic agent (“DTA”); at least one second entity (such as a settlement agent or system, for example) communicatively connected to a DTA; and a private communication network communicatively connecting the DTAs. The system also includes an Internet-based Graphical User Interface (referred to herein as a “GUI”) in which settlement information may be viewed by the entities. The GUI server is controlled by the settlement agent via the DTA of the settlement agent, such that settlement information viewable via the server is updated by the settlement agent through its DTA. The settlement agent also is communicatively connected to a Federal Reserve Bank via a dedicated line.

According to another aspect of the present invention a check settlement system for calculating a final net position between a first bank having a first DTA and a second bank having a second DTA is provided. The final net position is calculated at a main facility having a main DTA. The system operates by creating an ICL (described below) at the first bank. The ICL is validated at the first DTA, and the validated ICL is transmitted to the second DTA. A delivered message with a timestamp is sent from the first DTA to the main DTA when the ICL is successfully received by the second DTA. An ILCT (described below) for the second bank is retrieved from a database of ILCTs included in the main DTA. Further, the timestamp is compared to the retrieved ILCT for the second bank and, at the main facility, the final net position between the first and second banks is calculated based on a result of the comparison and predefined business rules.

These and other objects and aspects of the present invention will be apparent from the following detailed description of embodiments thereof.

### BRIEF DESCRIPTION OF THE DRAWINGS

The present invention will be more readily understood from the detailed description presented below considered in conjunction with the accompanying figures, of which:

FIG. 1 is a block diagram of a conventional ECP system in which electronic cash letters are sent to a central switch for distribution to paying banks;

FIG. 2 schematically depicts a system architecture, according to an embodiment of the present invention;

FIG. 3 depicts communication protocols utilized in an embodiment of the present invention;

FIG. 4 depicts a payload and transmittal flow, according to an embodiment of the present invention;

FIGS. 5A and 5B depict various hardware configurations, according to embodiments of the present invention;

FIG. 6 is a block diagram of an image exchange system with image-exchange capability, in which electronic cash letters and MICR data are sent to paying banks peer-to-peer via a private network, according to another embodiment of the present invention;

FIG. 7 is a block diagram of a DTA of a host bank, according to an embodiment of the present invention;

FIG. 8 is a block diagram showing functions performed by DTAs of a collecting bank, a paying bank, and a main facility, according to an embodiment of the present invention;

FIG. 9 is a block diagram of an arrangement of an Image Exchange system with a monitor and control system, according to an embodiment of the present invention;

FIG. 10 schematically depicts a system architecture, according to an embodiment of the present invention;

FIG. 11 is a block diagram showing detailed communications of the arrangement shown in FIG. 10, according to an embodiment of the present invention; and

FIG. 12 is a flowchart showing steps for calculating a net position, according to an embodiment of the present invention.

### DETAILED DESCRIPTION OF THE INVENTION

Terms

The following are terms used in describing various aspects of the present invention:

A “payload” is a file of data, and may include, as discussed below, a fixed account table (“FAT”) file, any type of ECP data file with images, an electronic payment (“EP”) data file, or any other financial-related or non-financial-related data file, as well as any combination(s) thereof.

A “message” is a set of control and/or summary information used to control and/or communicate information regarding a transmission of a payload.

A “transmittal” or “transmittal message” is a message containing information associated with a payload, and specifically may contain information identifying the sender and the receiver of the payload and/or summary information used to validate the integrity and contents of the payload.

An “amount brought/sent” represents the total amount that has been presented by a bank to all other banks.

An “amount received” represents the total amount that has been presented to a bank by all other banks.

A “multilateral balance” or “net position” is, with respect to a settlement on a given settlement day up to a specified settlement time, the total dollar amount of cash letter types of value presented by a bank to all other banks minus the total dollar amount of cash letter types of value received by the bank from all other banks related to that settlement, as shown on a settlement statement. If the total dollar amount of cash letter types of value presented by the bank to all other banks exceeds the total dollar amount of cash letter types of value received by the bank from all other banks, then the bank has a “credit multilateral balance.” Conversely, if the total dollar amount of cash letter types of value presented by the bank to all other banks is less than the total dollar amount of cash letter types of value received by the bank from all other banks, then the bank has a “debit multilateral balance.”

A “master account” means an account of the Settler with reserve and/or clearing balances on the books of a Reserve Bank.

A “Settler” means an entity that has established an account with a Reserve Bank and settles its own Balances, settles Balances for the account of another Participant, or both.

A “Reserve Bank” means one of the twelve Federal Reserve Banks.

“DSTU X9.37-2003” is an Accredited Standards Committee standard for electronic exchange of check-image data.

A “DTA” or “distributed traffic agent” is an electronic communication device that allows an exchange of data files and connects a computer system with a private communication network. Each DTA is associated with a single entity (e.g., a bank, a main facility, or the like).

Connect:Direct® is a software product from Sterling Commerce used to perform file transfers.

“ECP” is an acronym for Electronic Check Presentment file.

“ECPI” is an acronym for ECP with images.

“ECPD” is an acronym for ECP Disposition and is used to inform a collecting bank of the disposition of certain checks, e.g., return items, reversals, and holdover items.

“FATF” is an acronym for Fixed Account Table File.

“IRD” is an acronym for Image Replacement Document.

“ICL” is an acronym for Image Cash Letter.

“ICLR” is an acronym for Image Cash Letter Return.

“ILCT” is an acronym for Image Ledger Cutoff Time.

“GUI” is an acronym for an Internet-based Graphical User Interface in which settlement information may be viewed. P A “presentment” occurs when a receiving bank's DTA notifies a sending bank's DTA that a payload has been successfully received from the sending bank's DTA. A “timestamp” for the received payload is sent from the receiving bank's DTA to the sending bank's DTA, indicating a time of receipt.

A “settlement day” is the business day on which the Federal Reserve Bank settles cash letters presented thereto.

Image Exchange System (“IEX”)

An image exchange system according to an embodiment of the present invention communicates payloads and corresponding transmittals using a distributed, intelligent architecture, to obtain the benefits of central control and coordination of a conventional central switch without the above-discussed disadvantages of a hub-and-spoke configuration. Payloads of electronic check data (with or without image data), electronic payment data, and/or any other type of data are exchanged peer-to-peer between participating banks or other entities, thus eliminating or reducing the latency associated with processing such data through a central switch, the redundant processing among the banks and the central switch, and the risk of system-wide failure. Communicating transmittals containing control, tracking, and like information, corresponding to the payloads, to a central control facility retains the centralized control and coordination benefits of the central switch.

In particular, an outgoing payload is designated for at least one receiving (or destination) bank or entity. A DTA of a sending (or originating) bank or entity accepts the outgoing payload from the payment and/or check-processing computer system of the sending bank. A network address module of the DTA obtains a network address of the destination bank on a private communication network. The DTA reformats the outgoing payload according to a protocol of the network, and transmits the outgoing payload with a transmittal via the network to the network address of the destination bank.

A DTA of a receiving bank receives an incoming payload via the network from a sending bank, reformats it according to a format of the receiving bank's payment and/or check processing computer system, and passes the reformatted payload thereto.

A sending/originating bank can also be a receiving/destination bank, and vice versa, and the system can be implemented with both sending and receiving functionality.

The network address module may be configured to obtain a network address of the destination bank from a main facility via the network, or from a routing number (“RTN”) of the destination bank. Conversely, the network address module may obtain the RTN of the originating bank from the main facility via the network, or from the network address of the originating bank.

A network interface module may transmit control data via the network to a main facility, the control data being computed from the outgoing payload. The main facility may reconcile the control data computed from the outgoing payload with control data received from the originating bank.

Preferably, control data is included in a transmittal message that is separate from but uniquely associated with a payload. By using a transmittal message that is separate from the payload, the need for a DTA of a main facility to process the actual data of the payload can be eliminated or reduced substantially. Additionally, the control data can be used for system-wide purposes such as management reporting, settlement, and risk management, for example, all without requiring centralized processing of the payload itself. The control data also can be used to prevent the transmission of duplicate files and files not consistent with defined business rules such as processing dates, deadlines or inter-bank exchange partnerships.

As used herein, the term “module” refers to any combination of computer hardware and/or software that is configured to carry out a specified function. For example, a module may be a portion of a software program, e.g., a subroutine, executing on a general purpose personal computer or workstation. A module may include hardware such as, for example, memory components, (e.g., RAM, ROM, etc.), data busses, integrated circuits (“ICs”) for performing synchronous or asynchronous data input and output, ICs for performing computer network data transmission and reception, and application-specific integrated circuits (“ASICs”), and the like.

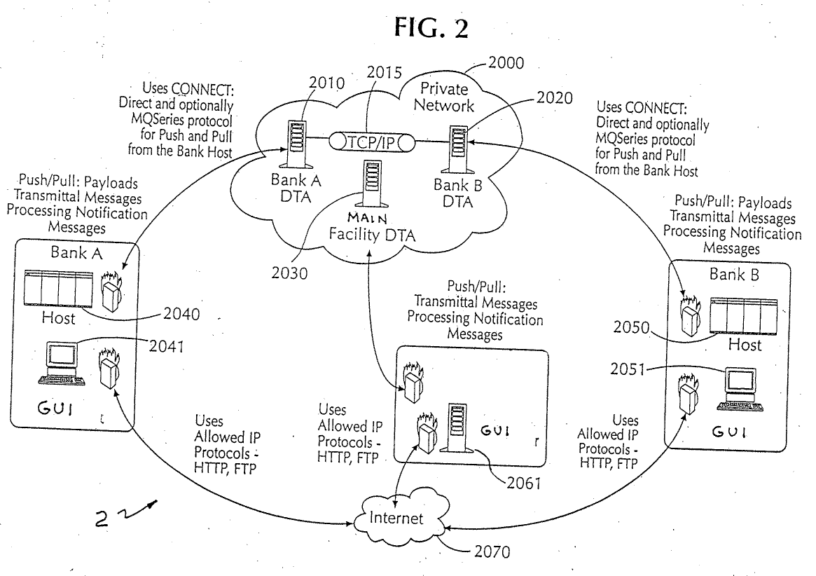

FIG. 2 schematically depicts an architecture of an image exchange (“IEX”) system 2 according to an embodiment of the present invention. The IEX system 2 includes a private network 2000 that is communicatively connected to systems operated by banks (e.g., Bank A's system 2040 and Bank B's system 2050). DTAs 2010, 2020, and 2030 serve as connecting points into the private network 2000. Each DTA is associated with a single entity (e.g., a bank or a main facility). However, multiple DTAs may be assigned to one or more entities.

Bank A's system 2040 communicates payloads, transmittal messages, and processing notification messages to and/or from a Bank A DTA 2010, preferably through a firewall. Similarly, Bank B's system 2050 communicates payloads, transmittal messages, and processing notification messages to and/or from a Bank B DTA 2020, preferably through a firewall. To send this information, each entity may access its corresponding DTA via a push/pull process, for example, using Connect:Direct® from Sterling Commerce, which is software used to perform file transfers between member banks and a private network. (Messages may be transferred if written as files.) Of course, the invention is not limited for use only with these software examples, and other suitable software may be used instead. Optionally, messages (only) may be moved with IBM MQSeries® send/receive queues. The Bank A DTA 2010 and the Bank B DTA 2020 communicate the payloads to each other, through, for example, a TCP/IP link 2015.

The banks' DTAs 2010 and 2020 also transmit transmittal messages and processing notification messages to and/or from a main facility DTA 2030 via the TCP/IP link 2015.

As is readily apparent to those skilled in the art, the IEX system 2 does not use a hub-and-spoke configuration, nor does the IEX system 2 have the attendant disadvantages of such a configuration, because the relatively large amounts of data in payloads are neither transmitted through nor processed by a central hub or switch. Instead, payloads are transmitted bank to bank via the network 2000. Further, only a relatively small amount of control information is communicated between banks and a main facility, e.g., in the form of transmittal messages and processing notification messages, which provides the central control and coordination benefits of a hub-and-spoke system. In addition, because the IEX system 2 does not require centralized processing of payload data, it can accommodate different types of payload data without requiring significant reprogramming or changes in the basic communication and control process.

To allow the banks to view control data of transmittal messages and processing notification messages, and information generated therefrom, a GUI server 2061 is provided, preferably through a firewall, to a public communication network such as, for example, the Internet 2070. Bank systems 2040 and 2050 each have a GUI, respectively 2041 and 2051, operatively connected thereto. The GUIs 2041 and 2051 are operatively connected to the GUI 2061 via the Internet 2070, through respective firewalls. Communication links to the Internet 2070 use standard IP protocols (e.g., HTTP, FTP, etc). The GUI 2061 provides control data and related information via the Internet 2070 to the GUIs 2041 and 2051 for bank access and viewing of the same.

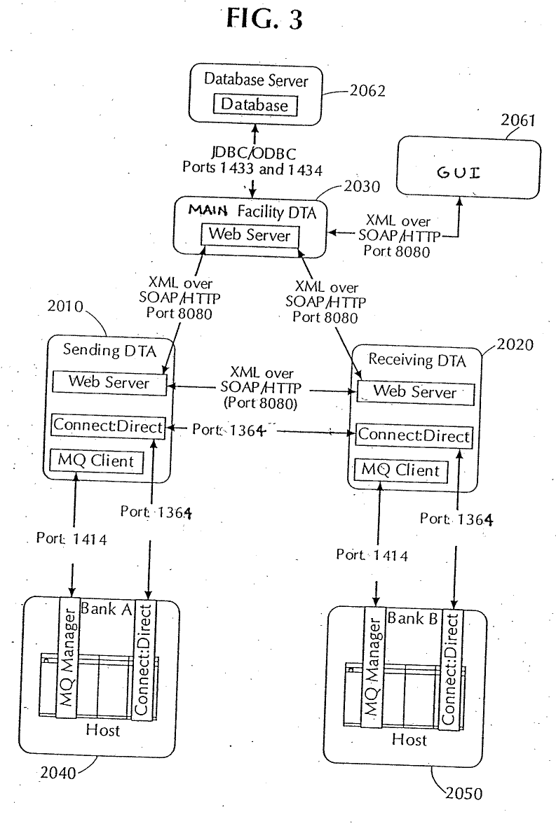

FIG. 3 depicts examples of communication languages and protocols preferably used among the Bank A DTA 2010 (configured as a sending DTA), the Bank B DTA 2020 (configured as a receiving DTA), the main facility DTA 2030, Bank A's system 2040, and Bank B's system 2050, as well as between the main facility DTA 2030 and a database server 2062 of the main facility, and between the main facility DTA 2030 and the GUI server 2061 of the main facility. As will be appreciated by persons skilled in the art, communication languages and protocols other than those listed in FIG. 3 may be used.

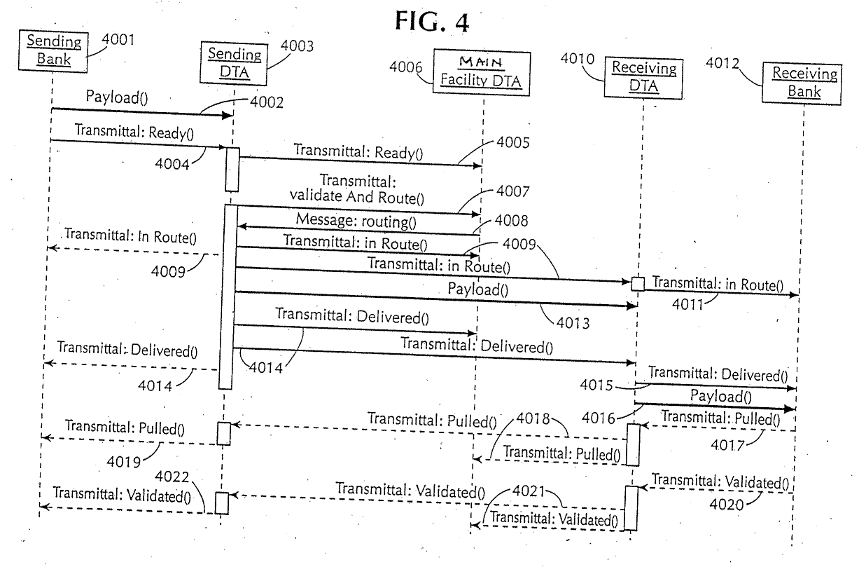

FIG. 4 depicts payload and transmittal events and flows according to an embodiment of the present invention. As shown in FIG. 4, a sending bank 4001, e.g., a financial institution, initiates the sending of a payload 4002. The payload 4002 is sent by the sending bank 4001 to a sending DTA 4003 associated with the sending bank 4001 via a Connect:Direct® script. Once the payload 4002 has been transmitted to the sending DTA 4003, the sending bank 4001 sends a transmittal message 4004, via a Connect:Direct® script or via an MQSeries® message queue, to the sending DTA 4003 to initiate transfer of the payload 4002. (Not shown are the processing notification messages, which are associated with the payload and the transmittal messages, that are communicated back to the sending bank 4001, as discussed above. The processing notification messages are used to notify the sending bank 4001 of any problems associated with the transmissions during validation, or of any problems associated with communications to other DTAs in the private network.)

Once a new transmittal has been recognized by a DTA software application, a notice 4005 of the new transmittal (and its associated payload) entering the IEX system 2 is sent to a main facility DTA 4006. The main facility DTA 4006 is used to track all the activity within the private network. Control totals and activity times are tracked to provide for processing flow activity and settlement information. After the sending DTA 4003 validates that a payload can be transmitted, a request 4007 is sent to the main facility DTA 4003 to perform a final validation (e.g., a duplicate checking), and to get an assigned routing for a receiving DTA 4010 (i.e., a DTA associated with a receiving bank 4012 that is to receive the payload 4002) to send the transmittal 4004 and the associated payload 4002. The main facility DTA 4006 returns routing information 4008 to the sending DTA 4003.

After the sending DTA 4003 has received the routing information 4008, the sending DTA 4003 generates an “in Route” transmittal message 4009, which is sent to the sending bank 4001, the main facility DTA 4006, and the receiving DTA 4010, thereby signaling that the payload 4002 is in route to the receiving DTA 4010. At flow 4011, the receiving bank 4012 pulls up the in Route transmittal message 4009 via Connect:Direct® or via an MQSeries® message queue monitored by the receiving bank 4012. At flow 4013, the payload 4002 is sent to the receiving DTA 4010 by the sending DTA 4003 via Connect:Direct®.

After the payload 4002 has been successfully sent to the receiving DTA 4010, the sending DTA 4003 sends a “delivered” transmittal message 4014 to the sending bank 4001, the main facility DTA 4006, and the receiving DTA 4010. At this point in time, “check presentment” has occurred. At flow 4015, the receiving bank 4012 pulls up the “delivered” transmittal message 4014 via Connect:Direct® or via an MQSeries® message queue monitored by the receiving bank 4012. This is a signal to the receiving bank 4012 that a payload is ready for pull-up. At flow 4016, the payload 4002 is received from the receiving DTA 4010 by the receiving bank 4012 and pulled up via Connect:Direct®. After successful completion of the transfer of the payload 4002 from the receiving DTA 4010 to an internal server of the receiving bank 4012, the receiving bank 4012 generates a “pulled” transmittal message 4017. This is basically the same transmittal message as the “delivered” transmittal message 4014, with the transmittal type changed from “delivered” to “pulled.” The “pulled” transmittal message 4017 is pushed to the receiving DTA 4010 via a Connect:Direct® script, or via an MQSeries® message queue. At flow 4018, the “pulled” transmittal message 4017 is forwarded to the main facility DTA 4006 and the sending DTA 4001. At flow 4019, the sending bank 4001 pulls up the “pulled” transmittal message 4017 via Connect:Direct® or via an MQSeries® message queue monitored by the sending bank 4001.

After successful completion of a payload validation process internal to the receiving bank 4012, the receiving bank 4012 generates a “validated” transmittal message 4020. This is basically the same transmittal message as the “delivered” transmittal message 4014, with the transmittal type changed from “delivered” to “validated.” The “validated” transmittal message 4020 is pushed to the receiving DTA 4010 via a Connect:Direct® script, or via an MQSeries® message queue. At flow 4021, the “validated” transmittal message 4020 is forwarded to the main facility DTA 4006 and the sending DTA 4001. At flow 4022, the sending bank 4001 pulls up the “validated” transmittal message 4020 via Connect:Direct® or via an MQSeries® message queue monitored by the sending bank 4001.

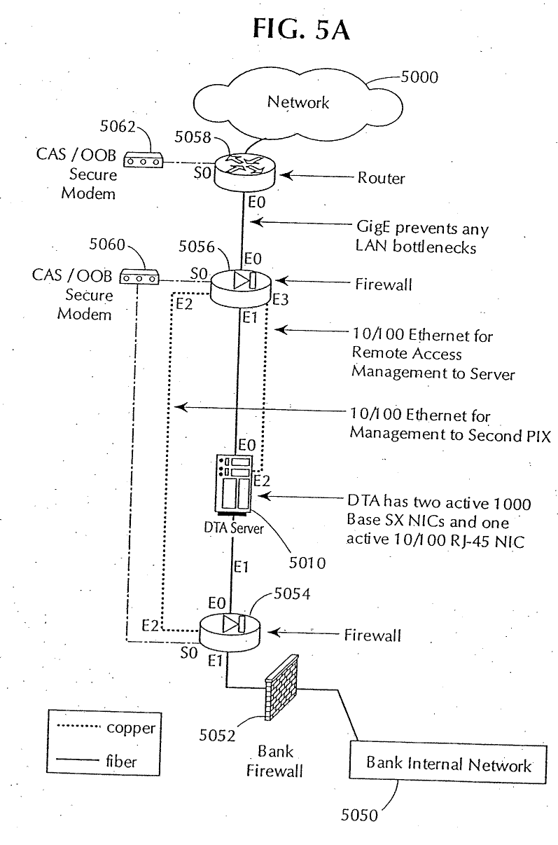

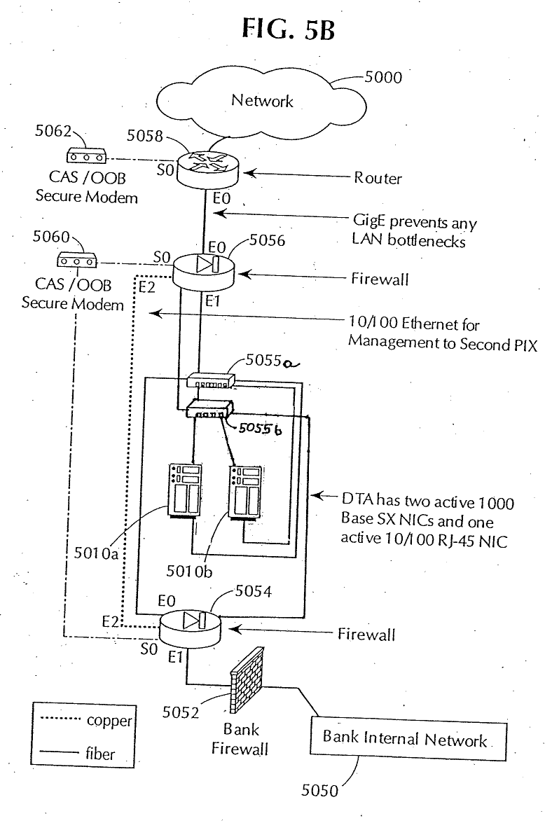

FIGS. 5A and 5B depict configurations for DTA hardware and other network and communication hardware for a carrier's network 5000, according to embodiments of the present invention. In FIG. 5A, an internal system 5050 or network of a bank is connected to a bank firewall 5052 using fiber, e.g., 1000Base SX fiber, which in turn is connected, via fiber, to a first network firewall 5054. The first network firewall 5054 is connected via fiber to a DTA server 5010, which has two active network interface cards (“NICs”), e.g., 1000Base SX NICs, and one active NIC, e.g., a 10/100 RJ-45 NIC. The DTA server 5010 is connected via fiber to a second network firewall 5056. In addition, the first and second network firewalls 5054 and 5056 are connected via a copper interface, and the DTA server 5010 and the second network firewall 5056 are connected via a copper interface. Both the first and second network firewalls 5054 and 5056 are communicatively connected to a secure modem 5060, e.g., a CAS/OOB secure modem. The second network firewall 5056 is connected via fiber to a network router 5058, which is communicatively connected to a secure modem 5062, e.g., a CAS/OOB secure modem. The network router 5058 is connected to the carrier's network 5000. This hardware configuration represents a single-carrier per data center and a single DTA server per site. Other possible hardware configurations that may used in the present invention include, for a single-carrier per data center, or two (FIG. 5B) DTA servers per site. In these figures, components 5055a and 5055b represent switches. As will be appreciated by one skilled in the art, other hardware configurations may be used.

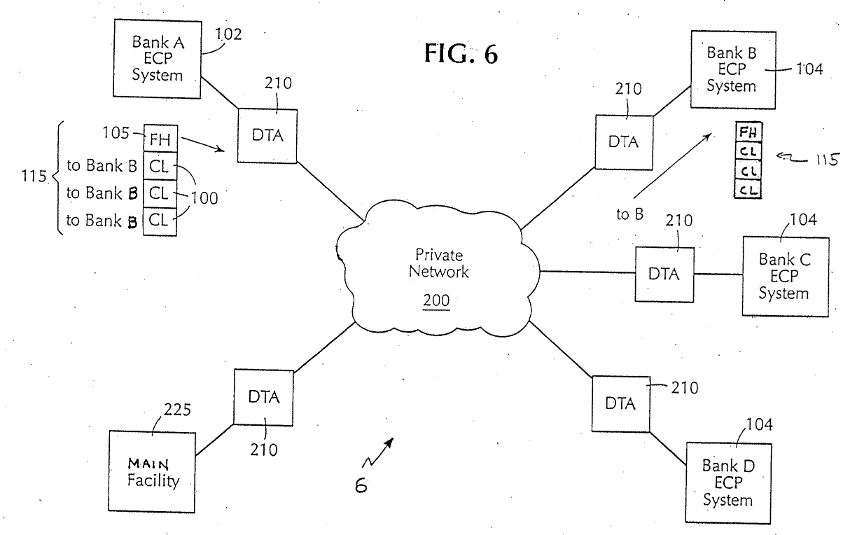

FIG. 6 schematically depicts an IEX system 6 according to another embodiment of the present invention, in which ECP data is exchanged peer-to-peer between banks via a network. In the IEX system 6, as will be described in more detail below, a check processing device is provided for processing paper checks, including sorting the checks and generating ECP data. A check processing computer is connected to the check processing device to accept the ECP data and to generate outgoing payloads of ECP data files with images.

As used herein, the phrase “ECP data” refers to any form of data representing encoded or printed information read from a paper check, e.g., account number, RTN, dollar amount, and check number, using MICR, optical character recognition, or any other means of reading information from paper. The ECP data may include an electronic cash letter (also referred to herein as “ECL”) that lists check information for checks drawn on a destination bank. The ECP data may also include image data read from a paper check, such as a digital image read from a paper check using an optical scanner (also referred to herein as “check image data”). It is to be understood that the phrase “ECP data” encompasses any of the above data, even though phrases such as “ECP data files with images” or “ECP and image data” also may be used herein.

The phrase “ECP data file” refers to a data structure or file containing ECP data. An ECP data file may or may not contain check image data, and may or may not be formatted in accordance with ANSI DSTU X9.37-2003 (or later versions thereof).

The phrase “ECPI file” refers to an ECP image file that contains actual check images as well as corresponding check data. The phrase “ECPD file” refers to an ECP disposition file that contains, for example, cash letters used to inform a collecting bank of the disposition of certain types of checks, i.e., to identify return items, reversal items, and holdover items.

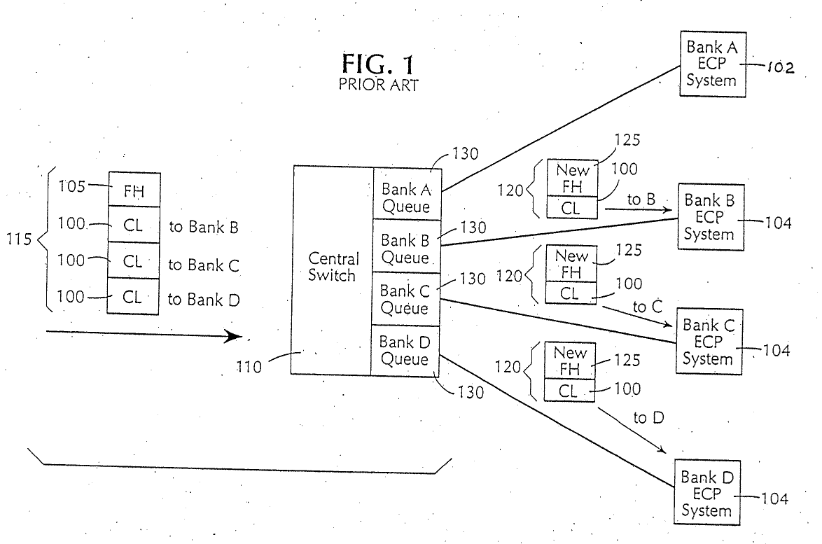

The IEX system 6 shown in FIG. 6 has image-exchange capability. In the IEX system 6, banks exchange ECP and check image data on a peer-to-peer basis through a shared, private network 200. Each bank 102 and 104 has a DTA 210 that acts as a network interface and a network node. Data may be transferred between these network nodes using any commonly known manner of network transmission of digital data, for example, in the form of packets using Internet protocol (“IP”). In such a case, each data packet has a header with source and destination IP addresses, which correspond to the unique IP addresses of a sending DTA and a receiving DTA, respectively. Data packets of a payload travel through the private network 200 from a sending bank's DTA 210 to a receiving bank's DTA 210, rather than being received, queued, and processed by a central switch. This eliminates central-switch latency associated with a conventional hub-and-spoke configuration, as discussed above with reference to FIG. 1.

In FIG. 6, a depositary bank 102, Bank A, sends ECP data with images, such as a group of electronic cash letters 100, through network 200, to a predetermined paying bank, such as Bank B 104 or another predetermined paying bank. The electronic cash letters 100 are grouped in a single combined electronic cash letter file 115 with a destination file header 105.

Prior to transmission, the electronic cash letter file 115 is formatted according to the data protocol of the network 200 and transmitted to paying Bank B 104 in a peer-to-peer exchange without dividing the electronic cash letter file 115. The DTAs 210 of the depositary bank 102 and the paying banks 104 also send transmittal messages containing control and other information relating to the transmission of the electronic cash letter file 115 to a main facility 225, which performs various monitoring and quality control functions.

Although check processing platforms typically offer some ability to review images for quality, the options vary greatly from vendor to vendor. Institutions wishing to participate in image exchange may want to implement an image quality assurance program using, for example, vendor-provided image quality tools, third-party tools, or manual periodic sampling methods to inspect images. One common mechanical cause of poor image quality is inadequate sorter camera maintenance by the sorter operator and/or the sorter vendor. For example, a dust spot on the camera lens can cause streaks across captured images until this quality defect is identified, which may result in the generation of thousands of poor quality images.

In a paper check processing environment, MICR data is embedded in and magnetically read from paper checks. In an image exchange environment, it becomes necessary for the paying bank to verify the MICR line data read from the paper check against MICR line data read from the check image. This verification function ensures that each item is represented by a complete and correct set of MICR data fields along with front and back image views for the corresponding item. If the MICR line data does not match the image MICR line data, the paying bank may reverse the item.

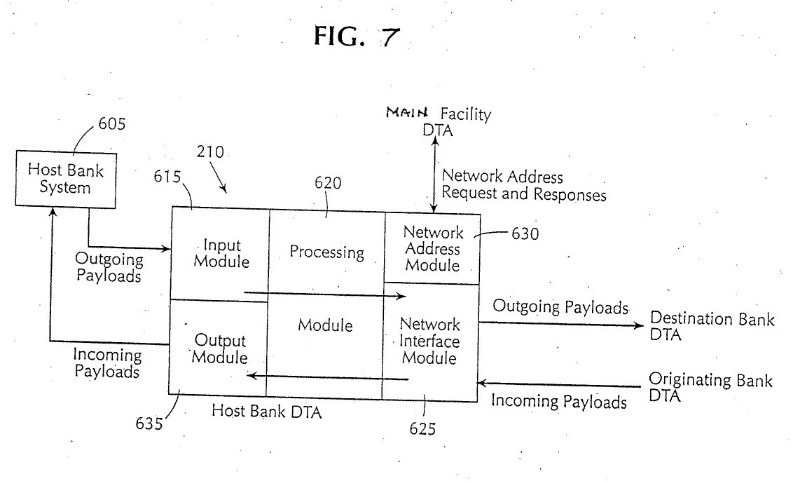

As discussed above, DTAs 210 are responsible for the reception and transmission of ECP data and ECP data files with images. FIG. 7 shows a block diagram of a DTA 210 connected to an image exchange system of a host bank 605, which is the portion of the bank's computer system that generates ECP data from deposited checks and processes ECP data received from other banks. In a preferred embodiment, the DTA 210 is implemented using software that is configured to execute on a general purpose, server-class personal computer. The various functions of the DTA 210 may be described in terms of software/hardware modules.

The DTA 210 has an input module 615, which accepts outgoing ECP data files with images generated by the ECP system 605 of the host bank from checks deposited at the host bank. Each ECP data file with images (as a payload) is destined for a particular paying bank (i.e., destination bank). As discussed above, the ECP data file with images may include image data in a standard format, such as ANSI DSTU X9.37-2003 (or later versions thereof). The input module 615 is designed to interface with and perform any necessary handshaking with the host bank's primary ECP file transfer application, e.g., Connect:Direct®, which runs over a TCP/IP connection. The outgoing ECP data file with images is passed to a processing module 620, which performs various functions to prepare the ECP data file with images for transmission, such as verification of its data format. Alternatively, the functions of the processing module 620 may be incorporated into the input module 615.

The outgoing ECP data file with images, i.e., the payload, is then passed to a network interface module 625, which adds the destination file header 105. The IP address for the destination bank is obtained from a network address module 630, which obtains the network address information (i.e., the IP address) from the DTA 210 of the main facility 225 via the private network 200 (FIG. 6). The network address module 630 also may maintain a database of such addresses, which may be updated periodically from the DTA 210 of the main facility 225.

In FIG. 7, the DTA 210 has an output module 635, which performs essentially an opposite function as the input module 615. The DTA 210 receives incoming ECP data files with images (payloads), via the network interface module 625, from collecting banks (i.e., depositary banks) for checks written on the host bank. Such files are received though the private network 200 by the network interface module 625, which reassembles received IP packets into the data file transmission format. In an alternative embodiment, the functions of the input module 615 and the output module 635 may be performed by a single combined input/output module. Furthermore, although the incoming and outgoing ECP data files are depicted in FIG. 7 as occurring on separate communication lines, such communication could readily be performed on a single bi-directional communication link. In such a case, the incoming and outgoing data is routed to the input module 615 and from the output module 635 as appropriate or is handled by a combined input/output module.

The incoming ECP data files with images are passed to the processing module 620, which performs functions such as format verification and acknowledgment transmission, and then to the output module 635. The output module 635 interfaces with the host bank's image exchange system, e.g., Connect:Direct®, and performs any necessary format conversion so that the data files can be accepted by the collecting bank's system. The output module 635 also performs any handshaking that may be necessary with the bank's collecting system.

Each DTA 210 preferably includes a computer platform that is an Intel-based (or equivalent), dual processor, server-class machine running at least 1.8 GHz. The DTA 210 preferably has a minimum of 2 GB of memory, a CD-ROM drive, a minimum of 72 GB of available disk space using RAID-0 (disk mirroring) or RAID-5 (disk striping) disk redundancy implementations, a tape backup, and at least one network interface card (NIC) supporting 100 megabit or gigabit Ethernet connectivity. The operation of each DTA 210 supports a high degree of parallelism, such that multiple files can be sent, received, and validated concurrently.

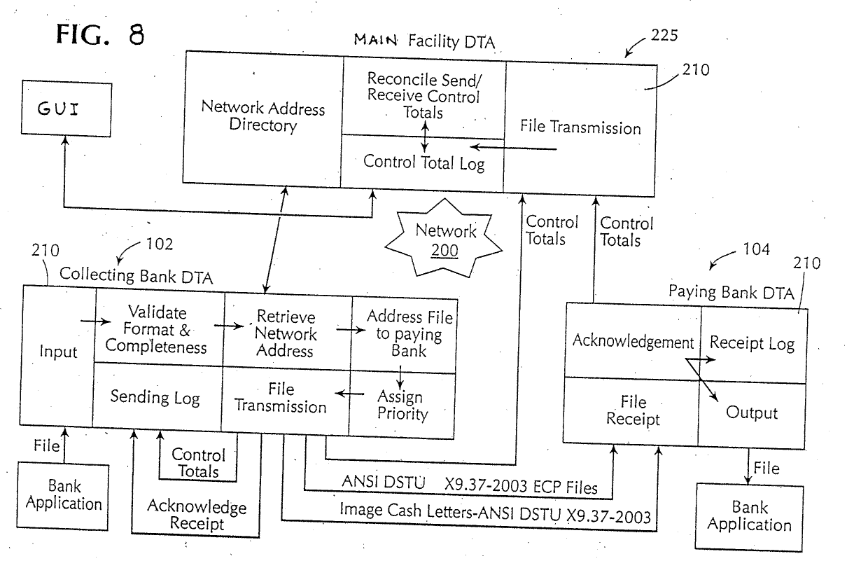

In addition to the reception and transmission of payloads and FAT files as payloads, the DTA 210, as shown in FIG. 8, performs a number of other functions relating to the handling of ECP data and image data in the private network 200. Prior to sending a file, the sending DTA 210, i.e., the DTA 210 of the sending bank 102 (e.g., the collecting bank) validates the file for correct format and completeness and prepares the file for transmission to the receiving bank 104 (e.g., the paying bank). The format verification ensures that the file adheres to the standard file structure for that particular type of file. This verification includes the capability to verify that an ECP data record (e.g., data read from a check MICR strip) exists for each image data record. This allows the sending DTA 210 to identify any extra images in the file (i.e., those images not associated with a ECP data record). The completeness verification ensures that the number of records in the file matches a control total. The sending DTA 210 also may check the total file size and compare it to control values for the particular file type.

The sending DTA 210 prepares the file for transmission by retrieving from a secure server the network IP address of the bank to which the file is to be sent. For example, the DTA 210 of the collecting bank 102 may retrieve the network IP address of the paying bank 104 from a network address directory stored at the DTA 210 of the main facility 225. The bank receiving the file may have more than one network address, each associated with a different type of file to be received. For example, a FAT file may be sent to a different address than an ECP image data file. Using multiple network addresses can help improve processing efficiency at the receiving DTA 210 by allowing files to be sorted by type prior to processing. Alternatively, the network address associated with a file type may be directed to receiving DTA 210 that is specifically configured to process that file type.

The sending DTA 210 also assigns a priority to the file prior to sending, based on criteria such as the following: receiving bank deadline, file type, file size, file value, and the most efficient use of telecommunications capacity. The priority of the file may be determined using a master table (not shown) of bank-established parameters corresponding to any or all of the above criteria. Such a table may be maintained by the DTA 210 of the main facility 225 and may be replicated on each bank's DTA 210. In addition, it may be possible for each bank to establish its own prioritization parameters in the master table. Files with the highest priority are delivered first. File priority may be automatically overridden by an algorithm, to ensure that all files are delivered by their associated deadlines.

The DTA 210 at the receiving bank 104 (i.e., the receiving DTA 210) is responsible for receiving the various types of payloads sent by the sending banks. In addition, the receiving DTA 210 generates bank address responses, file receipt acknowledgment messages, and reconcilement discrepancy advices, etc. Upon receiving a file, the receiving DTA 210 sends an acknowledgment receipt to the DTA 210 of the sending bank 102 and delivers the file to the appropriate banking application on the receiving bank's 104 computer system. The delivery may be accomplished by notifying the application that the file is ready for retrieval, e.g., by passing a token to the application.

The sending and receiving of payloads by the DTAs 210 through the private network 200 is subject to a sophisticated file tracking system. The DTA 210 of each bank maintains a log having entries for each file sent or received. The log entries include such information as: sending bank address or identification number, receiving bank address or identification number, and file priority. The log also records the date and time that each file was delivered by the bank's sending application to its DTA 210, sent by the DTA 210 to the private network 200, received by the receiving DTA 210, and delivered by the receiving DTA to the receiving application of the receiving bank. In addition, the log maintains control totals for the value of the items in the file, the number of items, and the file size in bytes. A copy of this information, including file time stamps, sender and receiver identification, and control totals, is also sent to the DTA 210 of the main facility 225 via a transmittal. The DTA 210 at each bank also receives and stores in its log acknowledgments received from receiving banks for each file sent.

The file tracking system is used to help reconcile discrepancies in the information maintained at the sending 102 and receiving 104 banks. Via the use of transmittals, the DTA 210 at the main facility 225, as described above, receives control and tracking information from both the sending 102 and receiving 104 banks for all files that are transmitted through the private network 200. The DTA 210 of the main facility 225 attempts to reconcile each file transmission by matching the control totals received from the sending 102 and receiving 104 banks. If there is a disagreement between the sending 102 and receiving 104 banks' control and tracking information, then the DTA 210 of the main facility 225 sends a reconcilement discrepancy advice to the DTAs 210 of the sending 102 and receiving 104 banks.

The DTA 210 of each bank is configured to receive reconcilement discrepancy notifications from the DTA 210 main facility 225. The bank's DTA 210 provides tools for correcting these discrepancies. Corrections are sent to the sending bank 102, the receiving bank 104, and the main facility 225, and are stored as addenda to the logs stored at each location.

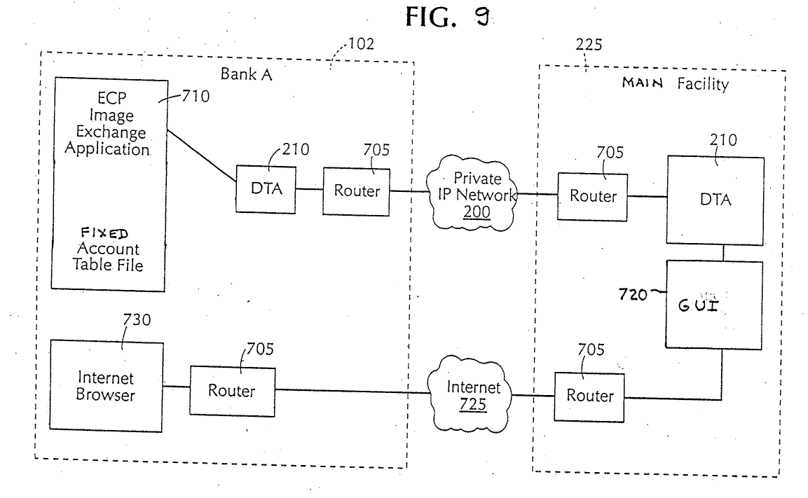

As discussed above, the DTA or DTAs 210 at each host bank are responsible for sending and receiving files relating to the bank's ECP image exchange system and fixed account table (FAT) system. As shown in FIG. 9, the DTA 210 at each bank, e.g., Bank A, sends and receives payload data through a router 705 connected to the private network 200. The DTA 210 is in turn connected to the bank's ECP image exchange application and fixed account table (FAT) application 710, which is the computer program that handles the sending and receiving of FAT data. As discussed above, the FAT data includes routing and account numbers and information on how checks drawn on particular accounts are to be handled by the collecting bank.

As discussed above, the main facility 225 has a DTA 210, or several DTAs 210 that receive control information via transmittal messages regarding all image exchange and FAT files that are transmitted through the private network 200. This information may also be made available to participating banks using a monitor and a GUI 720, which is a separate system to which the DTA 210 of the main facility 225 is connected. The GUI 720 is connected to a public network, e.g., the Internet 725, through a router 705 and browser 730, and configured to distribute information to the participating banks, as well as ECP and image exchange information.

To users of the IEX system 2 (FIG. 2), the DTA 210 functions as a “black box,” as there is no direct user interface with the DTA 210 in the preferred embodiment, although such an interface could be provided. Rather there is an indirect user interface through the GUI 720.

Settlement

With the IEX system 2 described above, a great deal of information may be transferred between banks in a quick and orderly manner. However, such transfer of information does not expedite the settlement of checks, which generally occurs once a day for items received during the previous 24-hour business day up to a pre-set daily settlement time.

To expedite check settlement, an embodiment of the present invention provides an image settlement system that automates settlement of image cash letters (“ICLs”) or electronic cash letters corresponding to ECP data files with images (ECPIs). ICLs are exchanged by banks connected to an IEX system, such as the IEX system 2 described above. According to the present invention, the image settlement system uses data exchanged in an IEX system and, based upon pre-established business rules agreed upon by users of the image settlement system, computes settlement amounts which are sent to the National Settlement Service (“NSS”) of a Federal Reserve Bank (“FRB”) for settlement. That is, the image settlement system utilizes certain existing hardware and software of an IEX system, and connects with the NSS of a FRB (also referred to herein as “NSSFRB”).

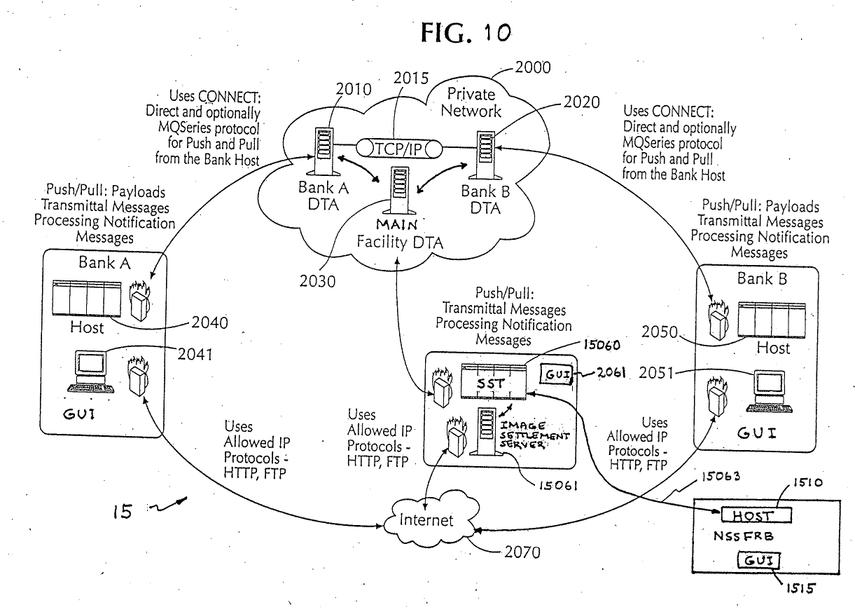

FIG. 10 schematically depicts an image settlement system 15, according to an embodiment of the present invention. Features in common with the IEX system 2 of FIG. 2 have the same reference numerals as in FIG. 2 and are discussed above. A repeated discussion of such features is omitted.

Further in a preferred embodiment of the invention, the communication events and flows (particularly the exchange of transmittals and/or messages) among the banks and DTAs described in the context of FIG. 4 apply equally to (are performed by) the banks and DTAs of the image settlement system 15 of FIG. 10. The discussion of those events and flows below will be repeated only to the extent deemed necessary.

In the image settlement system 15, a settlement service transmission system (“SST”) 15060, is communicatively connected with a host system 1510 of the NSSFRB via, for example, a dedicated line 15063. Preferably, the SST 15060 is a mainframe computer (e.g., a Unisys mainframe computer) that executes software applications for communicating with the host system 1510 of the NSSFRB. Also preferably, the image settlement system 15 is configured with hardware and software redundancy (not shown), to minimize any adverse effects of a communication interruption.

The SST 15060 is operably connected to the main facility DTA 2030 preferably through a firewall.

Further, the SST 15060 is operably connected to an image settlement server 15061 which is used by the image settlement system 15 to automatically compute settlement amounts using business rules and calculations that will be described later in detail.

The NSSFRB is further provided with a GUI 1515 for viewing settlement information.

The main facility DTA 2030 maintains a participant information file (“PIF”) or database (not shown in FIG. 10) which includes the image ledger cutoff times (“ILCTs”) of the participating entities and other information as will be described below.

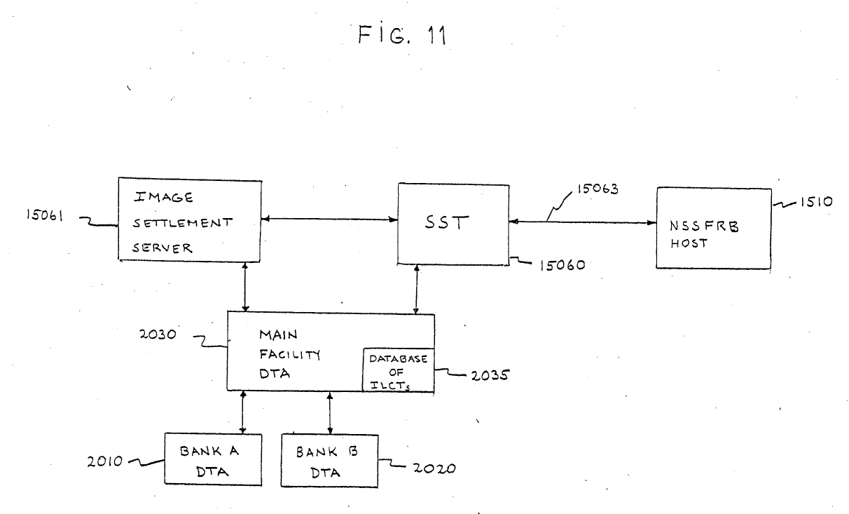

FIG. 11 is a block diagram showing a detail of the communications that are carried out in the arrangement shown in FIG. 10, according to an embodiment of the present invention.

In the example described below, the detail of communications carried out according to FIG. 10 will be used to explain an example of the steps performed to automatically calculate a net position according to a preferred embodiment of the present invention.

Features in FIG. 11 common with the IEX system 2 of FIG. 2 have the same reference numerals as in FIG. 2 and are discussed above. A repeated discussion of such features is omitted.

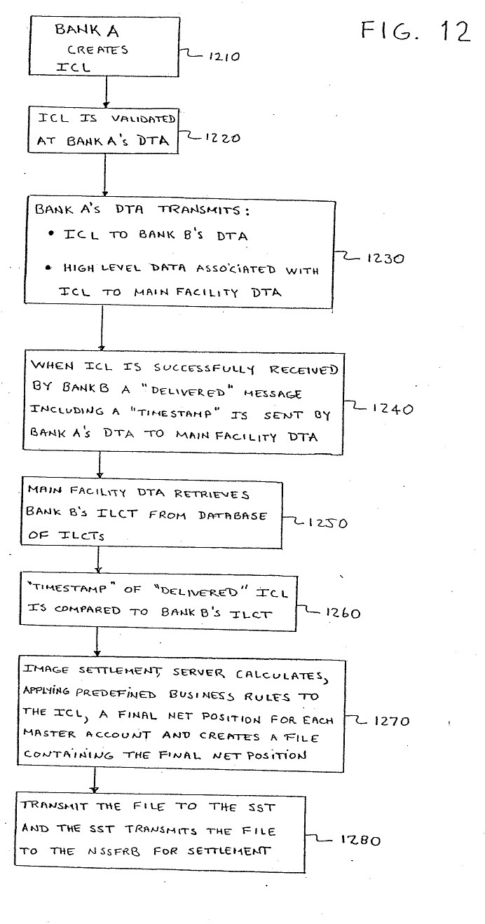

Further, as pointed out above with respect to FIG. 10, the communication events and flows described in the context of FIG. 4 also apply equally to, and supplement the communication events and flows (particularly the exchange of transmittals and/or messages) among, the banks and DTAs shown in FIGS. 11 and 12.

As shown in FIG. 11, the SST 15060 is connected to the NSSFRB 1510 via the dedicated line 15063. Further, the SST 15060 is connected to the image settlement server 15061 and to the main facility DTA 2030 which is also operably connected to the server 15061. The main facility DTA 2030 is operably connected to Bank A's DTA 2010 and Bank B's DTA 2020.

The main facility DTA 2030 includes a database of ILCTs 2035 of the participating banks which are used to compute settlement amounts, as will be described below in detail.

FIG. 12 is a flowchart showing an example of the steps performed to calculate a net position, according to an embodiment of the present invention.

At step 1210 Bank A's system 2040 (shown in FIG. 10) creates an ICL (or an ECPI) which is then validated at Bank A's DTA 2010 at step 1220. This validation step validates that the ICL can be transmitted based on predetermined validation criteria.

Bank A's DTA 2010 then transmits the validated ICL to Bank B's DTA 2020 (see also equivalent flow 4013 in FIG. 4), and also transmits high level data associated with the validated ICL (“ICL data”) to the main facility DTA 2030 at step 1230. In the preferred embodiment, the ICL data transmitted to the main facility DTA 2030 does not include images.

When the validated ICL is successfully received by Bank B's DTA 2020, “presentment” has occurred and a “delivered” message including a “timestamp” is sent by Bank A's DTA 2010 to the main facility DTA 2030 at step 1240. See also the transmittal flow 4014 in FIG. 4.

The main facility DTA 2030 then retrieves a predetermined ILCT (such as, e.g., Bank B's ILCT) from the database of ILCTs 2035 at step 1250 in response to receiving the “delivered” message.

The timestamp of the delivered ICL is compared by the main facility DTA 2030 to the retrieved Bank B's ILCT at step 1260 to determine when settlement should occur (if it does at all). Bank B's ILCT could indicate 12:00 noon or 4:00 p.m., for example, or some other predetermined time or other criteria.

Then, the image settlement server 15061 applies predefined business rules (described below in detail) to the ICL data (i.e., the ICL data from step 1210) stored in the main facility DTA 2030, taking into account a result of the above comparison, to calculate a final net position for each master account and creates a file containing the final net position at step 1270, based preferably on the “Settlement Calculation Formula” criteria and other applicable rules described below, for example, although in other embodiments, other criteria/rules may be employed instead.

The file containing the final net position calculated by the image settlement server 15061 is then transmitted to the NSSFRB 1510 via the SST 15060 using the dedicated line 15063 at step 1280.

The image settlement server 15061 computes settlement amounts at step 1270, or determines that no settlement occurs, using the business rules and calculations described below, such as, for example the “Settlement Calculation Formula” rules (and other applicable rules) described below, although in other embodiments other suitable rules may be employed instead.

Rules Governing Computation of a Settlement

In an exemplary embodiment of the present invention, settlement occurs two times each business day: at noon and at 4 p.m. eastern time (“ET”). (It is to be understood that the specific time values used herein are intended to be illustrative examples, and the scope of the present invention also covers time values other than those used in the examples.) The inclusion of image cash letters in a settlement is based upon a set of business rules. Throughout the description below, the following dates will be used for clarity of description:
Business day—the current processing day of the IEX system 2
Next business date—the next business following the next business day
Current (given) settlement day—the next business day upon which settlement occurs
Next settlement day—the day following the current settlement day that settlement can occur

The business rules are as follows:
Without exception, all banks using the IEX system 2 will settle through the image settlement system 15.
All files marked with “P” (production), contribute to the current settlement unless excluded, as described below in “Exclusions from the Calculation of Settlement”; all cash letters are contained within the file.
All cash letter types, e.g., ECP/ECPI, ECPD, ICL, and ICLR, contribute to the settlement calculation; all cash letters are contained within the file. All cash letters with the current business day or the current business day plus one (1) contribute to the next scheduled settlement. However, cash letters with the next business day do not automatically have its settlement held over one extra business day, because presentment has occurred.
All computations for settlement are performed using data from the cash letter transmittal associated with the cash letter payload. The image settlement system 15 relies on the cash letter transmittal data for settlement.

Accounting for Cash Letters

According to an embodiment of the present invention, each bank has a set of accumulators (e.g., eight accumulators) for the purpose of accumulating the total amount brought and the total amount received:
“A1-by-bank”—the amount brought/sent for the first settlement of the given settlement day (noon) (ET)
“A1-to-bank”—amount received for the first settlement of the given settlement day (noon) (ET)
“A2-by-bank”—the amount brought/sent for the second settlement of the given settlement day (4 p.m.) (ET)
“A2-to-bank”—amount received for the second settlement of the given settlement day (4 p.m.) (ET)
“A3-by-bank”—the amount brought/sent for the first settlement of the next settlement day (noon) (ET) following the given settlement day
“A3-to-bank”—the amount received for the first settlement of the next settlement day (noon) (ET) following the given settlement day “to” the bank by all other banks
“A3-by-bank-prior”—the amount brought/sent yesterday in A3-by-bank for the first settlement of the given settlement day (noon) (ET)
“A3-to-bank-prior”—amount received yesterday in A3-to-bank for the first settlement of the given settlement day (noon) (ET)
   Cutoffs

According to an embodiment of the present invention, noon (ET) and 4 p.m. (ET) are established as cutoff times. Specific rules governing a particular settlement are described below.

An Image Ledger Cutoff Time (also referred to herein as “ILCT”) is the time up to which a receiving bank will accept cash letters for the current settlement day. A bank may set its image ledger cutoff time between 6:00 a.m. (ET) and 4:00 p.m. (ET). The ILCTs are stored in the database 2035 (shown in FIG. 11) of the main facility DTA 2030. Specific rules governing how Image Ledger cutoffs affect the noon and 4 p.m. settlements are described below.

Rules Governing Cash Letter Types

According to an embodiment of the present invention, rules pertaining to different types of cash letters are as follows:
ECP/ECPI—Under all circumstances the ECPI cash letter transmittal data is used for computation of a settlement at step 1270 of FIG. 12, for example, because the ECPI cash letter transmittal is necessary for presentment to have occurred.
   Under all circumstances the ECP cash letter transmittal is informational and does not contribute to the settlement calculation.
   ECPD—There are two types of “ECPD” or electronic check presentment disposition cash letters:
   Exceptions—ECPD cash letter transmittals of this type contribute to the settlement calculation of the current settlement day; and
   Returns—ECPD cash letter transmittals of this type contribute to the settlement calculation on the next settlement day.
ICL—“ICL” or image cash letter transmittal data is used for computation of a settlement on the current settlement day.
ICLR—Cash letter transmittal data for an “ICLR” or image cash letter return contribute to a settlement calculation on the next settlement day.
   Rules Governing Cutoff Times

The following examples apply the rules governing cash letter types, according to an embodiment of the present invention:
When a receiving bank does not set an image ledger cutoff time, settlement of image cash letters is governed solely by the cutoffs.
   Cash letter types ECP/ECPI, ECPD (Exceptions), and ICL received after 9 p.m. (ET) of the current business day and before noon (ET) of the current settlement day, for the current business day having the current business day or the next business day in the cash letter transmittal will settle at noon (ET) of the current settlement day. The accumulators A1-by-bank and A1-to-bank are updated.
   Cash letter types ECP/ECPI, ECPD (Exceptions), and ICL received after noon (ET) of the current settlement day and before 4 p.m. (ET) of the current settlement day for the current business day having the current business day or the next business day in the cash letter transmittal will settle at 4 p.m. (ET) of the current settlement day. The accumulators A2-by-bank and A2-to-bank are updated.
   Cash letter types ECPD (Returns), and ICLR received after 9 p.m. (ET) of the current business day and before 9 p.m. (ET) of the next business day, for the current business day having the current business day or the next business day in the cash letter transmittal will settle at noon (ET) on the next settlement day. The accumulators A3-by-bank and A3-to-bank are updated.
   The last settlement of the day occurs at 4 p.m. (ET). Any cash letter arriving after 4 p.m. (ET) and before 9 p.m. (ET) will settle at noon on the next settlement day; this includes ECPD (Returns) because the next settlement day changes to the “current” settlement day at 9 p.m. (ET) each business day when the image settlement system 15 changes its business day. The accumulators A3-by-bank and A3-to-bank are updated.
When a receiving bank sets an image ledger cutoff time and file type, the set ILCT governs whether cash letters are included in a settlement on the current settlement day or the next settlement day.
   If the ILCT is set to be before noon (ET):
      Cash letter types ECP/ECPI, ECPD (Exceptions), and ICL arriving before the ILCT settle at noon (ET) on the current settlement day. The accumulators A1-by-bank and A1-to-bank are updated.
      Cash letter types ECP/ECPI, ECPD (Exceptions), and ICL arriving after the ILCT settle at noon (ET) on the next settlement day. The accumulators A3-by-bank and A3-to-bank are updated.
      Cash letter types ECPD (Returns) and ICLR arriving anytime during the current business day settle at noon (ET) on the next settlement day. The accumulators A3-by-bank and A3-to-bank are updates.
   If the ILCT is set after noon (ET) but before 4 p.m. (ET):
      Cash letter types ECP/ECPI, ECPD (Exceptions), and ICL received after 9 p.m. (ET) of the current business day and before noon (ET) of the current settlement day for the current business day, having the current business day or the next business day in the cash letter transmittal will settle at noon (ET) of the current settlement day. The accumulators A1-by-bank and A1-to-bank are updated.
      Cash letter types ECP/ECPI, ECPD (Exceptions), and ICL received after noon (ET) of the next business day and before the ILCT of the next business day for the current business day, having the current business day or the next business day in the cash letter transmittal will settle at 4 p.m. (ET) of the current settlement day. The accumulators A2-by-bank and A2-to-bank.
      Cash letter types ECP/ECPI, ECPD (Exceptions), and ICL arriving after the ILCT settle at noon (ET) of the next settlement day. The accumulators A3-by-bank and A3-to-bank are updated.
      Cash letter types ECPD (Returns) and ICLR arriving anytime during the current business day settle at noon (ET) on the next settlement day. The accumulators A3-by-bank and A3-to-bank are updated.
   If the ILCT is set for 4 p.m. (ET):
      All cash letter types ECP/ECPI, ECPD (Exceptions), ECPD (Returns), ICL, and ICLR arriving anytime between 4 p.m. (ET) and 9 p.m. (ET) settle at noon (ET) on the next settlement day. The accumulators A3-by-bank and A3-to-bank are updated.
         Settlement Calculation Formula

According to an embodiment of the present invention, as used in the method of FIG. 12, for example, a settlement calculation produces a Multilateral Balance for a bank for a given settlement for a given settlement day. A settlement calculation formula uses data placed in appropriate accumulators based on the rules stated in the “Rules Governing Computation of a Settlement” section described above. Also, see the “Exclusions from the Settlement Calculation” section described below.

The following formula is used to compute a settlement time for the noon settlement for each bank:

The Multilateral Balance is equal to an Amount Brought minus an Amount received where:
1. Amount Brought is equal to the sum of A1-by-bank plus A3-by-bank-prior; and
2. Amount Received is equal to the sum of A1-to-bank plus A3-to-bank.

Should the Multilateral Balance produce a positive result the bank will have a credit Multilateral Balance (credit) and can expect to receive a credit as part of this settlement. Should the Multilateral Balance produce a negative result the bank will have a negative Multilateral Balance (debit) and can expect to be debited to satisfy its settlement obligation.

The following formula is used to compute a settlement for the 4 p.m. settlement time for each bank:

The Multilateral Balance is equal to the Amount Brought minus the Amount received where:
1. Amount Brought is equal to A2-by-bank; and
2. Amount Received is equal to A2-to-bank.

Should the Multilateral Balance produce a positive result the bank will have a credit Multilateral Balance (credit) and can expect to receive a credit as part of this settlement. Should the Multilateral Balance produce a negative result the bank will have a negative Multilateral Balance (debit) and can expect to be debited to satisfy its settlement obligation.

Exclusions from the Settlement Calculation

According to an embodiment of the present invention, there are certain business rules defined to exclude particular image cash letters from settlement (i.e., that don't contribute to settlement):
All files marked with “T” for test do not contribute to the settlement; all cash letters are contained within the file.
All cash letters identified as image replacement documents “IRD” do not contribute to the settlement.
All cash letters of all types sent to or received from a Federal Reserve Bank.
   Participant Information File (“PIF”)

According to an embodiment of the present invention, the PIF includes the following additional information:
settlement contact and alternate(s)
additional treeing for rollup display
settlement times, e.g., noon and 4 p.m.
   RTN Control

Control to ensure that RTNs in the system remain eligible for settlement through two consecutive settlements when an RTN is leaving the system is required.

Continuation of Settlement One Day Past Termination

According to an embodiment of the present invention, in the event a bank ceases to participate in the settlement process of the image exchange system 15, it will be required to remain and participate in one additional settlement past its active exchanging of files in the IEX system 2 because the bank may have presented or received ECPD (Returns) or ICLR cash letters on its last day of active exchange of files.

Settlement File Processing

According to an embodiment of the present invention, the noon settlement must complete before the 4 p.m. settlement can be closed, calculated, and sent to the Federal Reserve Bank for processing. The processing rules at the NSSFRB are that when multiple files arrive at the same time for the same settlement arrangement, the settlement files are processed serially. Under this procedure, the file being processed must complete before the next one in the queue is processed.

Image settlement:
1. An Image Settlement module creates a shareable settlement file on the mainframe.
2. The mainframe has a group set up for each of the two image settlements each with one exchange. No participant information is stored in the SST system on the mainframe.
3. The mainframe starts looking for the file at the specified settlement time for each settlement. Once it finds the file, an action item appears to close the group and initiate settlement.
4. The file is sent to the FRB by SST. A new Results data set is added to the data management system (“DMSII”) database. This results table is filled with the results from the FRB whether the file was accepted or not. If it was not accepted, the text of the reason is stored here (e.g. ‘Participant XXX has insufficient funds’)
5. The mainframe re-titles the file once it sends it to the FRB. If settlement needs to be recast because either the file was rejected or a participant fails, the file is regenerated by the Image Settlement module with a new revision number. The SST system reopens the settlement in order to resend the file.
6. If a file is rejected by the FRB because a participant is missing from its system and subsequently added by the FRB, the SST system will increment the revision number in the file and resend it to the FRB.
7. The SST system updates the status of the settlement in the same manner as it does for all other groups so this status can be displayed on the GUIs (e.g. open, closed etc.)
   Settlement Process Description

According to an embodiment of the present invention, in the new image environment, DSTU X9.37-2003 ECP Data files are created first and transmitted to the Collecting Bank's DTA within the Image Ledger Cutoff Time and using rules established by agreement. The Collecting Bank's DTA performs required edits and creates a status log for this file. The file is then be transmitted to the Paying Bank's DTA where it is logged in. Upon instructions of the Paying Bank's DTA to Push the Data File to the Paying Bank's Main Frame, The Paying Bank's DTA sends an acknowledgment back to the main facility DTA log to acknowledge that the file was pulled and validated.

The Collecting Bank then creates a DSTU X9.37-2003 ECP Data with Image file for each DSTU X9.37-2003 ECP Data file that had been transmitted earlier. This file is transmitted within the Image Ledger Cutoff Time and rules established by agreement. The same edit and tracking scenario is followed. Once the DSTU X9.37-2003 ECP Data with Image file has been acknowledged by the Paying Bank's DTA, presentment has occurred provided that at least the DSTU X9.37-2003 ECP Data with Image file is received prior to the Image Ledger Cutoff Time established by the Paying Bank.

If a member bank does not establish a specific Image Ledger Cutoff Time within an electronic check clearing system environment (e.g., the image settlement system 15 of FIG. 10), it is deemed to have set an Image Ledger Cutoff Time of 4:00 P.M. Eastern Time.

The DSTU X9.37-2003 ECP Data file and the DSTU X9.37-2003 ECP Data with Image file, as well as an Image Cash Letter (ICL) that is created by the Collecting Bank is comprised of single, or multiple cash letters, that are destined for the same bank endpoint. The cutoff time for receipt of a DSTU X9.37-2003 ECP Data file or a DSTU X9.37-2003 ECP Data with Image file or an ICL that will be used to calculate settlements is the Image Ledger Cutoff Time that is set by each bank on the IEX.

Settlements of Images and Image related files are performed at 12:00 and 4:00 p.m. Eastern Time on each business day of the year. All banks participate in each settlement unless specific Image Ledger Cutoff Times have been established by a Paying Bank. In these cases, the settlement time for these Paying Banks will be the first settlement immediately subsequent to the Image Ledger Cutoff Time established by the Paying Bank.

The truncated ECP Data file is sent and received in the DSTU X9.37-2003 format.

The Collecting Bank sends DSTU X9.37-2003 ECP Data file followed by an image file(s) (DSTU X9.37-2003 ECP Data with Image File) by the Image Ledger Cutoff Time established between the partner banks by agreement.

The Paying Bank receives DSTU X9.37-2003 ECP Data file and DSTU X9.37-2003 ECP Data with Image file(s) by the Image Ledger Cutoff Time established between the partner banks by agreement.

The Paying Bank has the ability to identify true returns, as well as any missing, ineligible, or poor image quality items, and to notify the Collecting Bank via the creation of a DSTU X9.37-2003 Image Return Item Disposition file (of returns and/or exceptions) or an ICLR (Image Cash Letter With Return Items.)

The Paying Bank has the ability to recognize a DSTU X9.37-2003 ECP data with image record that does not match a DSTU X9.37-2003 ECP data record (i.e., an extra image without an accompanying data record), and to report the missing image to the Collecting Bank via a courtesy telephone call. It will be clear to someone skilled in the art that the ability to transmit an extra image without the accompanying data record is highly improbable.

Pre-production files processed in the production environment contain a “T” in field 3, position 5 of the File Header Record (Type 01). The image settlement system will ignore all transmittal files for DSTU X9.37-2003 ECP Data files and DSTU X9.37-2003 ECP Data with Image file(s) that contain a “T” in this position.

DSTU X9.37-2003 ECP Data files and DSTU X9.37-2003 ECP Data with Image file(s) can be resent by the Collecting Bank under certain conditions.

A participant retransmits when a payload and its corresponding transmittal fail DTA validation. The participant first determines what caused the initial DTA validation failure (e.g., this may be visible via IBM MQSeries® messages going back from the DTA), and then make the necessary corrections to the payload and/or transmittal. Before retransmitting the corrected payload and transmittal, the participant chooses either of the following two options to prevent this payload from, again, failing DTA validation by being rejected as a duplicate payload.

The participant makes the following changes to the payload and corresponding transmittal to prevent the payload from being rejected:
1. The (‘01 record’) ‘File ID’ is changed in the payload.
2. The ‘Transmittal ID’ is changed in the actual transmittal to match the ‘File ID’.
3. The unique ‘Cash Letter ID’ for each cash letter in the transmittal is changed. It is not necessary to change the cash letter IDs in the payload as the DTA does not check the unique ‘Cash Letter ID’ in the transmittal against the payload, just against the database to verify that the cash letter is not a duplicate.

DSTU X9.37-2003 Data with Image files that are used for the creation of IRD's must carry within their transmittal, under the field “payload contents,” a type called “ird”. This will designate the file as a “Production Print File”. The transmittals that are a result of these “ird” files are not entered into any settlement calculation.

Summary totals of each cash letter are captured by the main facility DTA (also referred to as “Super DTA”). The items in the cash letter are captured at the summary level (RTN, Forward Items Sent, Forward Dollars Sent, Forward Items Received, Forward Dollars Received, Adjustments Items sent, Adjustment Dollars sent, Adjustment Items Received, Adjustment Dollars Received, Return Items Sent, Return Dollars Sent, Returns Items Received, and Return Dollars Received).

A copy of the summary information is moved to a data file which updates the image settlement system.

Cash letters or items that have been refused for settlement may cause the Paying Bank to reverse internal postings.

The Paying Bank then creates a DSTU X9.37-2003 Disposition file, on the same business day, that carries a reason code of “U” for Unusable-poor quality image, “I” for missing image or “Q” for ineligible Image. This DSTU X9.37-2003 Disposition file receives the entrie(s) contained in the originating forward cash letter that the Paying Bank has decisioned for non settlement.

The details of the transmittal from the DSTU X9.37-2003 Disposition file are captured by the Super DTA and a copy of the detail record is sent to the image settlement system.

A Net Position Display screen (e.g., a GUI) also indicates a Master RTN net position that consolidates the banks multiple RTN's under a single Master RTN that may be used for “Net Settlement Purposes”. This Master RTN must be a physical RTN as it can house settlement data for its own site as well as the settlement data that will be rolled up from affiliated sites within the Image Exchange System.

If a Paying Bank is operating under a single RTN this RTN is listed as the Master RTN for Settlement purposes. This RTN is listed on the customer information file of a Federal Reserve Bank (for example the Federal Reserve Bank of New York) and can be used to identify a bank, for example, for Settlement purposes.

At 12:00 noon and again at 4:00 p.m. Eastern Time, a copy of the settlement detail information is moved to a data file for transmission to a Federal Reserve Bank. These respective files represent the final settlement numbers for each of the respective settlements of 12:00 noon and 4:00 p.m. Eastern Time.

A settlement is calculated for each RTN indicated as a master RTN by the bank owning that RTN. Multiple RTN's listed under the Master RTN could have net settlement cast under the Master RTN.

Upon completion of the settlement calculation GUI displays to an authorized user the final position for each Master RTN viewable by that user.

At a set time (e.g., no later than 12:00 noon and/or 4:00 p.m. Eastern Time) the SST transmits the settlement figures to the Federal Reserve Bank.

Upon notification from the Federal Reserve Bank that settlement has been completed, a broadcast message is sent indicating the final position for the RTN of the bank logged into CheckView. Notification from the Federal Reserve Bank is usually within 5 minutes.

Since each Image Bank participates in both the 12:00 noon and 4:00 p.m. Eastern Time Settlements any files that are transmitted to the electronic check clearing system subsequent to 12:00 noon Eastern Time are settled at 4:00 p.m. Eastern Time unless the Image Ledger Cutoff Time of the settling bank is prior to 12:00 noon Eastern Time.

The Collecting Bank sends a DSTU X9.37-2003 ECP Data file followed by a DSTU X9.37-2003 ECP Data with Image File by the Image Ledger Cutoff Time established between the partner banks by agreement. The Paying Bank receives DSTU X9.37-2003 ECP Data file and DSTU X9.37-2003 Data with Image file(s) by the Image Ledger Cutoff Time established between the partner banks by agreement. Presentment has been made and settlement takes place at either 12:00 noon or 4:00 p.m. Eastern time depending on Paying Bank's Image Ledger Cutoff Time.

The Collecting Bank sends DSTU X9.37-2003 ECP Data file followed by a DSTU X9.37-2003 ECP Data with Image File after the Image Ledger Cutoff Time established between the partner banks by agreement. The Paying Bank receives DSTU X9.37-2003 ECP Data file and DSTU X9.37-2003 Data with Image file(s) subsequent to their Image Ledger Cutoff Time. In this example, presentment has been made and Settlement takes place at 12:00 noon Eastern Time on the following business day.

The Collecting Bank sends DSTU X9.37-2003 ECP Data file within the Paying Bank's Image Ledger Cutoff Time. If the DSTU X9.37-2003 ECP Data with Image File is never delivered to the Paying Bank's DTA, the Paying Bank receives DSTU X9.37-2003 ECP Data file within its Image Ledger Cutoff Time but never receives the DSTU X9.37-2003 Data with Image file(s). In this example, presentment has not been made and settlement does not take place. The Paying Bank will inform the Collecting Bank of the missing file via creation of a non-monetary disposition file (e.g., an ECPD-E).

The Collecting Bank sends DSTU X9.37-2003 ECP Data file, which is delivered subsequent to the DSTU X9.37-2003 ECP Data with Image File. All files are received within the Image Ledger Cutoff Time established between the partner banks by agreement. The Paying Bank receives DSTU X9.37-2003 ECP Data file subsequent to the DSTU X9.37-2003 Data with Image file(s) but within its Image Ledger Cutoff Time. In this example, presentment has been made and settlement takes place at 12:00 noon or 4:00 p.m. Eastern time depending on the Paying Bank's Image Ledger Cutoff Time.

The Collecting Bank sends DSTU X9.37-2003 ECP Data file which is delivered subsequent to the DSTU X9.37-2003 ECP Data with Image File. All files are received subsequent to the Image Ledger Cutoff Time. The Paying Bank Receives DSTU X9.37-2003 ECP Data file subsequent to the DSTU X9.37-2003 Data with Image file(s) and subsequent to its Image Ledger Cutoff Time. In this example, presentment has been made and settlement takes place at 12:00 noon Eastern Time on the next business day. Settlement information will be derived from the transmittal of the DSTU X9.37-2003 Data with Image File.

The Collecting Bank sends DSTU X9.37-2003 ECP Data file, which is never delivered to the Paying Bank. The Collecting Bank sends the DSTU X9.37-2003 ECP Data with Image File, this file is received within the image ledger cutoff time established between the partner banks by agreement. The Paying Bank never receives the DSTU X9.37-2003 ECP Data file but does receive the DSTU X9.37-2003 Data with Image file(s) within the Image Ledger Cutoff Time. In this example, presentment has been made and settlement takes place at 12:00 noon or 4:00 p.m. Eastern Time on the same business day depending on the Paying Bank's Image Ledger Cutoff Time. Settlement information is derived from the Transmittal of the DSTU X9.37-2003 Data with Image File.

The Collecting Bank sends DSTU X9.37-2003 ECP Data file followed by a DSTU X9.37-2003 ECP Data with Image File by the Image Ledger Cutoff Time established between the partner banks by agreement. The Paying Bank receives DSTU X9.37-2003 ECP Data file and DSTU X9.37-2003 Data with Image file(s) by the Image Ledger Cutoff Time established between the partner banks by agreement. During the matching process the Paying Bank discovers missing images, blobs on the DSTU X9.37-2003 Data with Image File. Presentment has been made and settlement takes place at either 12:00 noon or 4:00 p.m. Eastern Time depending on Paying Bank's Image Ledger Cutoff Time. In this example, the settlement will be based on the full value of the Transmittal of the DSTU X9.37-2003 Data with Image File. The Paying Bank will create a Disposition File for the problem items and mark these as Monetary Reversals (Reason Code=I).

The Collecting Bank sends DSTU X9.37-2003 ICL Image with Data file by the Image Ledger Cutoff Time established between the partner banks by agreement. The Paying Bank Receives DSTU X9.37-2003 ICL Image with Data file by the Image Ledger Cutoff Time established between the partner banks by agreement. In this example, presentment has been made and settlement takes place at either 12:00 noon or 4:00 p.m. Eastern time depending on the Paying Bank's Image Ledger Cutoff Time.

The Collecting Bank sends DSTU X9.37-2003 ICL Image with Data file subsequent to the Image Ledger Cutoff Time established between the partner banks by agreement. The Paying Bank Receives DSTU X9.37-2003 ICL Image with Data file subsequent to their Image Ledger Cutoff Time. In this example, presentment has been made and settlement will take place at 12:00 noon Eastern Time on the next business day.

All DSTU X9.37-2003 ICL files and DSTU X9.37-2003 ICLR files that are either destined for the Federal Reserve Bank or being transmitted from the Federal Reserve Bank are settled by the Federal Reserve Bank and are therefore eliminated from the main facility settlement. The main facility settlement system utilizes the electronic check clearing system PIF file “FRB Bank” indicator to determine a Federal Reserve Bank site. All Federal Reserve Bank sites will be label “Yes” and as such will be eliminated from the main facility settlement.

Normal and Abnormal Settlement: Process Description & Examples

The image settlement system uses information derived from ECP Transmittal Files and Disposition Transmittal Files to compute each Image Bank's Bilateral Balance vis-à-vis each other Image Participant and each Settling Participant's Multilateral Balance or Aggregate Balance. These positions are computed on a rolling basis throughout the day and will be available for review by each Image Participant.

Upon receipt of a settlement file from the image exchange system, the electronic check clearing system submits the Settlement File to the Federal Reserve Bank on behalf of the image exchange system as its Settlement Agent.

Upon acceptance of the Settlement File, the Federal Reserve Bank attempts to debit the designated Federal Reserve Account of each Debtor Settling Participant for the amount of its debit Aggregate Balance.

If the attempt to debit a Settling Participant's Account is successful, the Federal Reserve Bank immediately credits the Settlement Account with the amount debited from the Settling Participant's Account.

When the Federal Reserve Account of each of the Debtor Settling Participants has been debited and the amount credited to the Settlement Account, the Federal Reserve Bank debits the Settlement Account and makes a corresponding credit to the Federal Reserve Account of each Creditor Settling Participant. When all of these debits and credits have been posted, the Federal Reserve Bank notifies the electronic check clearing system that the Settlement File has been fully processed.

If the Federal Reserve Bank is unable to debit the Federal Reserve Account of a Debtor Settling Participant, it immediately notifies the electronic check clearing system of the situation and that settlement is held up until it can debit the Federal Reserve Account of the Debtor Settling Participant or the Debtor Settling Participant is removed from the settlement.

A Settling Participant having a technical problem must notify the electronic check clearing system as soon as possible of the nature of the problem, and an estimate of the time by which the Settling Participant expects the problem to be corrected. If the electronic check clearing system believes that the problem causing the delay can be corrected in sufficient time to allow settlement to be completed before 1:00 p.m. Eastern Time for the regular 12:00 Noon Settlement and 5:00 p.m. Eastern Time for the normal 4:00 p.m. Settlement, the electronic check clearing system establishes a delayed settlement schedule for that day and sends a notice of the delayed settlement schedule to each Settling Participant. When a delayed settlement is held open for settlement on the next Business Day, the electronic check clearing system does not begin to process settlement for a subsequent day until settlement for the prior day is completed. If the electronic check clearing system realizes that the settlement could be beyond one and one half hours past the originally scheduled settlement time; the electronic check clearing system may at its discretion “recast” the settlement by removing the Defaulting Debtor Settling Participant.

If the electronic check clearing system determines that settlement under a normal or delayed settlement schedule will not be completed because of operational difficulties and that there is no possibility of completing the settlement during the processing window of the Federal Reserve Bank, the electronic check clearing system may either recast settlement and follow the procedure for settlement recast or hold the settlement over to the following business day. If settlement is held over to the following Business Day, the electronic check clearing system does not begin to process settlement for a subsequent day until settlement for the prior day is completed.

While the present invention has been described with respect to what is presently considered to be the preferred embodiments, it is to be understood that the invention is not limited to the disclosed embodiments. Likewise, the times mentioned herein are merely examples and are not limiting to the scope of the invention. To the contrary, the invention is intended to cover various modifications and equivalent arrangements included within the spirit and scope of the appended claims.

What is claimed is:

1. A method for processing a financial check transaction between a plurality of financial institutions, including at least first and second institutions, the method comprising steps of:
providing electronic check data, relating to at least one check to be paid by the second institution, from the first institution to the second institution to effect an automatic check presentment; and
automatically performing an electronic settlement determination for the at least one check, based on the electronic check data and predetermined business rules.

2. The method of claim 1, further comprising a step of notifying the first and second institutions of a result of the performing step.

3. The method of claim 1, further comprising a step of notifying a Federal Reserve Bank of a result of the performing step.

4. The method of claim 1, wherein the predetermined business rules are associated with the second institution and are applied to the electronic check data to perform the electronic settlement determination.

5. The method of claim 1, wherein the performing step includes retrieving the predetermined business rules from a database associated with a main facility.

6. The method of claim 1, further comprising a step of determining an image letter cutoff time of the second institution, and wherein the performing step is based on the image ledger cutoff time.

7. The method of claim 1, wherein the performing step includes conducting a settlement at least two times a day to process plural financial check transactions.

8. The method of claim 1, further comprising a step of identifying a type of the electronic check data, wherein the performing step includes applying respective predetermined business rules based on the identified type of the electronic check data.

9. The method of claim 8, wherein the type of the electronic check data is one of an image cash letter (ICL) and electronic check presentment data with images (ECPI).

10. A check settlement method for calculating a final net position between a first bank having a first DTA and a second bank having a second DTA, the method comprising:
creating an ICL at the first bank;
validating the ICL at the first DTA;
transmitting the validated ICL to the second DTA;
transmitting high level data associated with the ICL to a main DTA of a main facility;
sending from the first DTA to the main DTA a delivered message including a timestamp;
retrieving an ILCT for the second bank from a database associated with the main DTA;
comparing the timestamp to the retrieved ILCT for the second bank; and
at the main facility, calculating a final net position between the first and second banks based on a result of the comparison and predefined business rules, wherein the calculating of the final net position is performed automatically.

11. The check settlement method according to claim 10, wherein the final net position is calculated at an image settlement server included in the main facility.

12. The check settlement method according to claim 11, further comprising:
creating a file containing the final net position; and
transmitting the file to a NSSFRB for final settlement.

13. The check settlement method according to claim 12, wherein the transmission of the file to the NSSFRB is performed by a SST via a dedicated line.

14. The check settlement method according to claim 10, wherein the ILCT of the second bank includes a plurality of ILCTs.

15. A system for processing a financial check transaction, comprising:
a plurality of financial institutions, including at least first and second institutions, the first and second institutions arranged to communicate electronically with each other to effect an automatic check presentment; and
a main facility arranged to automatically perform an electronic check settlement determination based on the presentment and predetermined business rules.

16. The system of claim 15, wherein the main facility is arranged to notify the first and second institutions of a result of the electronic check settlement determination.

17. The system of claim 15, wherein the main facility is arranged to notify a Federal Reserve Bank of a result of the electronic check settlement determination.

18. The system of claim 15, wherein the predetermined business rules are associated with the second institution and are applied by the main facility to electronic check data relating to the presentment to perform the electronic check settlement determination.

19. The system of claim 15, wherein the main facility is arranged to retrieve the predetermined business rules from a database associated with a main facility.

20. The system of claim 15, wherein the main facility is arranged to determine an image ledger cutoff time of the second institution, and wherein the electronic check settlement determination is performed based on the image ledger cutoff time.

21. The system of claim 15, wherein the electronic check settlement determination is performed at least two times a day to process plural financial check transactions.

22. The system of claim 15, wherein the main facility is arranged to identify a type of the electronic check data involved in the transaction, and the electronic check settlement determination is performed by the main facility and includes applying respective predetermined business rules based on the identified type of the electronic check data.

23. The system of claim 22, wherein the type of the electronic check data is one of an image cash letter (ICL) and electronic check presentment data with images (ECPI).

24. A computer program, embodied in a computer-readable medium, that when executed processes a financial check transaction between a plurality of financial institutions, including at least first and second institutions, comprising:
code for providing electronic check data, relating to at least one check to be paid by the second institution, from the first institution to the second institution to effect an automatic check presentment; and
code for automatically performing an electronic settlement determination for the at least one check, based on the electronic check data and predetermined business rules.

25. The computer program of claim 24, further comprising code for notifying the first and second institutions of a result of performing the electronic settlement determination.

26. The computer program of claim 24, further comprising code for notifying a Federal Reserve Bank of a result of performing the electronic settlement determination.

27. The computer program of claim 24, wherein the code for performing the electronic settlement determination includes code for applying predetermined business rules associated with the second institution to the electronic check data to perform the electronic settlement determination.

28. The computer program of claim 24, wherein the code for performing the electronic settlement determination includes code for retrieving the predetermined business rules from a database associated with a main facility.

29. The computer program of claim 24, further comprising code for determining an image ledger cutoff time of the second institution, wherein the code for performing the electronic settlement determination performs the electronic settlement determination based on the image ledger cutoff time.

30. The computer program of claim 24, wherein the code for performing the electronic settlement determination conducts a settlement at least two times a day to process plural financial check transactions.

31. The computer program of claim 24, further comprising code for identifying a type of the electronic check data, wherein the code for performing the electronic settlement determination applies respective predetermined business rules based on the identified type of the check data.

32. The computer program of claim 31, wherein the type of the electronic check data is one of an image cash letter (ICL) and electronic check presentment data with images (ECPI).
